(19) United States
(12) Patent Application Publication
(10) Pub. No.: US 2010/0109997 A1
(43) Pub. Date: May 6, 2010

(54) DISPLAY DEVICE WITH BACKLIGHT LOCAL AREA ILLUMINATION CONTROL CIRCUIT

(75) Inventors: Yu-Ming Chen, Hsinchu (TW); Yung-Kang Fan, Hsinchu (TW)

Correspondence Address: APEX JURIS, PLLC, 12733 LAKE CITY WAY NORTHEAST, SEATTLE, WA, 98125, US

(73) Assignee: MITAC TECHNOLOGY CORP., Hsinchu (TW)

(21) Appl. No.: 12/266,544

(22) Filed: Nov. 6, 2008

(51) Int. Cl. G09G 3/36

(52) U.S. Cl. 345/102

(57) ABSTRACT

Disclosed is a display device with a backlight local area illumination control circuit, which employs a backlight local area illumination control circuit to control an illumination zone of the backlight module of the display device. The backlight local area illumination control circuit includes a plurality of illuminants, an illuminant controller, and an illuminant driving circuit. Based on a backlight illumination zone selection signal received, the illuminant controller selectively drives the illuminants of the backlight module so as to form a local illumination zone in the backlight module corresponding to a local displaying area in which a target image is to be displayed on the global displaying area to have the target image displayed in the local displaying area of the display device.

### BACKGROUND OF THE INVENTION

1. Field of the Invention

The present invention relates to a radio frequency identification system that is capable of preventing signal collision, in particular, to a radio frequency identification system with multi-band transmission for preventing signal collision.

2. Related Art

A conventional liquid crystal displays (LCD) is generally comprised of a displaying panel and a backlight module. The displaying panel displays an image thereon by controlling pixels thereof. The backlight module is positioned at the rear side of the display device to provide a backlight source. The illuminants that are ordinarily used in a backlight module include a cold cathode fluorescent lamps (CCFL) and light-emitting diodes (LEDs). For all the applications currently known, for image pre-displaying in an electronic device, the backlight module is set in a completely activated condition and switches that control the pixels in the displaying panel determine if to pass the light from the backlight source. Thus, for many electronic devices, such as a notebook computer, a liquid crystal displaying screen, a mobile phone, and personal digital assistant (PDA), the backlight module is a high power consumption component and it remains a challenge to be solved to put the backlight module in an operation of best performance.

For example, U.S. Pat. No. 6,457,279 discloses a touch panel structure that has a backlight module using a CCFL as an illuminant, together with a reflector board, a light guide, a diffuser board, and a polarization conversion board, which reflect, guide, and uniformly distribute the light for projection onto the liquid crystal panel to provide brightness for image displayed on the liquid crystal panel.

However, the illuminant of the conventional backlight module can only be set in a full-screen-area-on condition. In other words, even only a local area that is a portion of the full screen is needed to be set in operation, the illuminant of the backlight module still has to be turned on for the whole screen area and it is in generally impossible to make any adjustment in response to a desired area for displaying operation, and consequently, unnecessary power consumption occurs. For a portable electronic device, such as mobile phone, the capacity of a battery pack is very limited and unnecessary consumption of power will directly affect the usable time of the mobile phone. For the illuminant used in the conventional backlight module, both a CCFL and an LED, is subjected to a limitation imposed by the lifespan thereof that is closely relevant to the time period that it is set in operation to give off light.

### SUMMARY OF THE INVENTION

In view of the above discussed problems of the known techniques, the present invention provides a display device that eliminates unnecessary power consumption by employing a backlight local area illumination control circuit to control the driving and thus light emission of each illuminant of a backlight module so that the backlight module of a display device is operated to selectively only illuminate a local illumination zone thereof corresponding to a global or local displaying area of the display device.

In an embodiment of the present invention, a display device with a backlight local area illumination control circuit is provided, which employs a backlight local area illumination control circuit to control an illumination zone of the backlight module of the display device. The backlight local area illumination control circuit includes a plurality of illuminants, an illuminant controller, and an illuminant driving circuit, and the illuminant driving circuit includes a first driving circuit and a second driving circuit. Based on a backlight illumination zone selection signal received, the illuminant controller selectively drives the illuminants of the backlight module by means of the first driving circuit and the second driving circuit so as to form a local illumination zone in the backlight module corresponding to a local displaying area in which a target image is to be displayed on the global displaying area to have the target image displayed in the local displaying area of the display device.

The present invention uses a backlight local area illumination control circuit to control an illumination zone of a backlight module of a display device in order to prevent the illuminants of the backlight module from being set in an activated condition for a long while for the purposes of effectively reducing unnecessary power consumption and to prevent the illuminants of the backlight module from unnecessary activation for the purposes of extending the service life of the illuminants.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein below for illustration only, and thus is not limitative of the present invention, and wherein:

FIG. 1 shows a system block diagram in accordance with a first embodiment of the present invention;

FIG. 2 is an exploded view showing a display device in accordance with the first embodiment of the present invention;

FIG. 3 is a schematic view illustrating a backlight local area illumination control circuit in accordance with the first embodiment of the present invention;

FIG. 4 is a schematic view illustrating a global illumination zone in accordance with the first embodiment of the present invention;

FIG. 5 is a schematic view illustrating a local illumination zone in accordance with the first embodiment of the present invention; and

FIG. 6 is a schematic view illustrating a backlight local area illumination control circuit in accordance with a second embodiment of the present invention.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description refers to the same or the like parts.

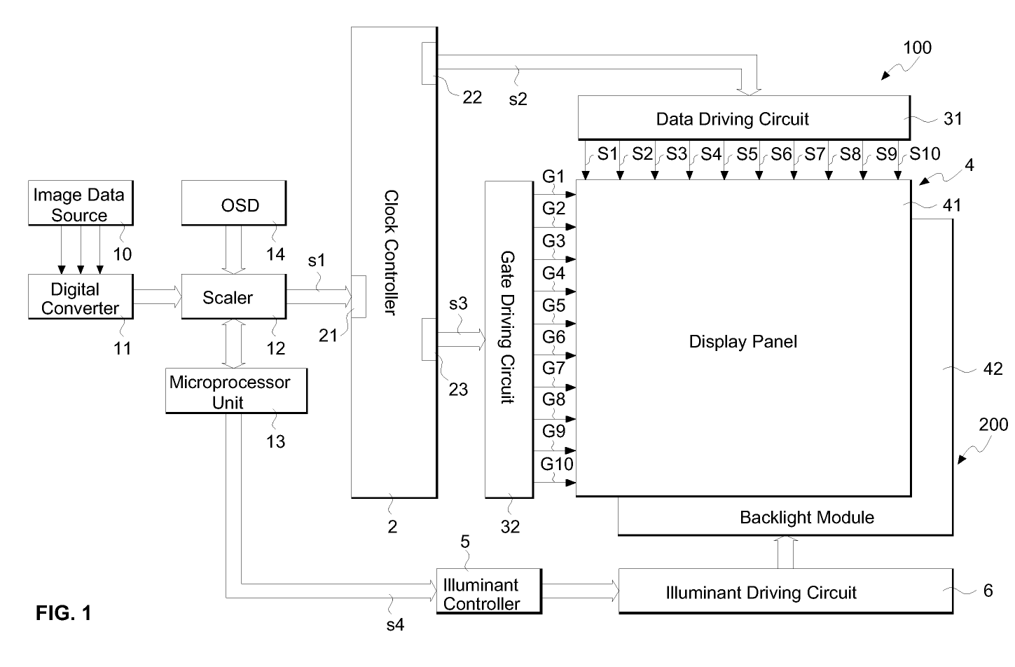

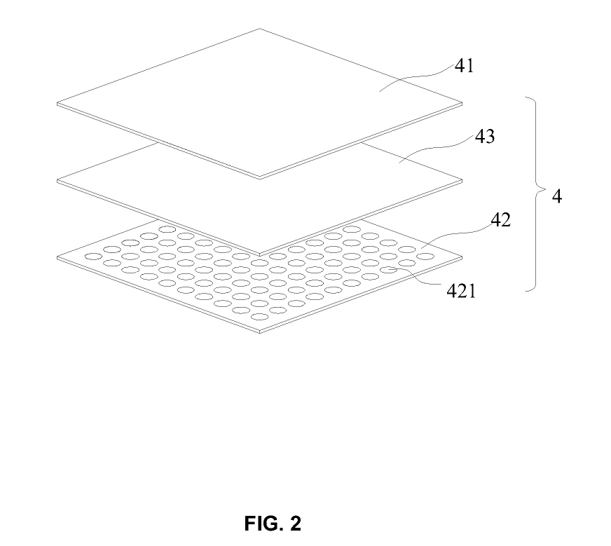

With reference to FIGS. 1 and 2, wherein FIG. 1 shows a system block diagram in accordance with a first embodiment of the present invention and FIG. 2 shows an exploded view of a display device in accordance with the first embodiment of the present invention, as shown, an image data source 10 applies a RGB analog signal that is comprised of red, green, and blue components to an analog to digital converter (ADC) 11 for conversion of the analog signal into a digital signal, which is then applied to a scaler 12. The scaler 12 performs adjustment with respect to image-related parameters regarding to image resolution or shape and size contained in the digital signal provided by the analog to digital converter 11.

The scaler 12 is connected to a microprocessor unit 13 and an on-screen display (OSD) 14. The OSD 14 allows for fine adjustment of displaying-related parameters, such as brightness and contrast of screen displaying and horizontal and vertical positioning, of the image data that have been subjected to adjustment realized through the scaler 12. Further, the OSD 14 can be embedded or optional according to the numbers of language and font that the system can support.

During the processing of image data, the microprocessor unit 13 carries out reception and conversion of the image signal and interlaced scanning. In addition, it also helps the OSD 14 in appearance adjustment and font conversion. The scaler 12 transmits the adjusted and integrated image data as an image data signal s1 to a display panel driving circuit 100. The a display panel driving circuit 100 comprises a timing controller 2, a data driving circuit 31, and a gate driving circuit 32 and functions to control the pixel units of a display panel 41 of a display device 4.

The timing controller 2 comprises an image signal source connection portion 21, a data driving circuit connection port 22, and a gate driving circuit connection port 23. The image signal source connection portion 21 of the timing controller 2 receives the image data signal s1 and in turn provides a data driving circuit control signal s2 through the data driving circuit connection port 22 thereof to the data driving circuit 31. The data driving circuit 31 comprises a plurality of data lines S1-S10 connected to the display panel 41 for transmitting the RGB-indicative digital signals to desired pixel units.

The timing controller 2 further provides a gate control signal s3 through the gate driving circuit connection port 23 thereof to the gate driving circuit 32. The gate driving circuit 32 comprises a plurality of gate lines G1-G10 connected to the pixel units on the display panel 41 of the display device 4 for controlling and driving a desired image displaying area on the display panel 41 through the gate control signal s3.

The display device 4 comprises a backlight module 42 to serve as a backlight source for the display device 4. A diffusion board 43 is arranged between the backlight module 42 and the display panel 41. The display device 4 controls an illumination zone of the backlight module 42 through a backlight local area illumination control circuit 200. The backlight local area illumination control circuit 200 comprises a plurality of illuminants 421, an illuminant controller 5, and an illuminant driving circuit 6. The illuminant controller 5 is connected to the illuminant driving circuit 6 and selectively drives each illuminant 421 of the backlight module 42 in accordance with a backlight illumination zone selection signal s4 provided by the microprocessor unit 13.

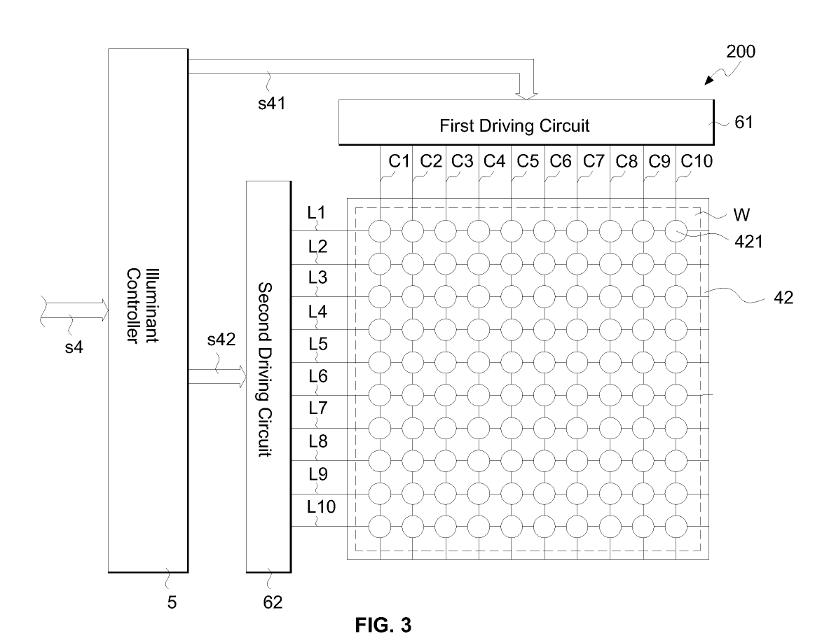

Referring to FIG. 3, which is a schematic view of the backlight local area illumination control circuit in accordance with a first embodiment of the present invention, as shown, the illuminants 421 are arranged in a matrix in the backlight module 42 and are set corresponding to the display panel 4 so that the light generated by each illuminant 421 is projected toward and thus illuminates the display panel 41 and a global illumination zone W that corresponds to a full displaying area of the display panel 41 is defined.

In the embodiment illustrated, the illuminant driving circuit 6 comprises a first driving circuit 61 and a second driving circuit 62. The first driving circuit 61 comprises a plurality of first driving control lines C1-C10, each being connected to a terminal of a corresponding one of the illuminants 421 in each column of the matrix. The second driving circuit 62 comprises a plurality of second driving control lines L1-L10, each being connected to an opposite terminal of a corresponding one of the illuminants 421 in each row of the matrix.

The illuminant controller 5 receives the backlight illumination zone selection signal s4 and generates a first driving signal s41 to the first driving circuit 61 to provide a driving voltage to the illuminants 421 through the first driving control lines C1-C10. The illuminant controller 5 also generates a second driving signal s42 to the second driving circuit 62 to provide a driving voltage to the illuminants 421 through second driving control lines L1-L10. When an illuminant 421 is simultaneously driven by both the first driving circuit 61 and the second driving circuit 62, the illuminant 421 is enabled and gives off light.

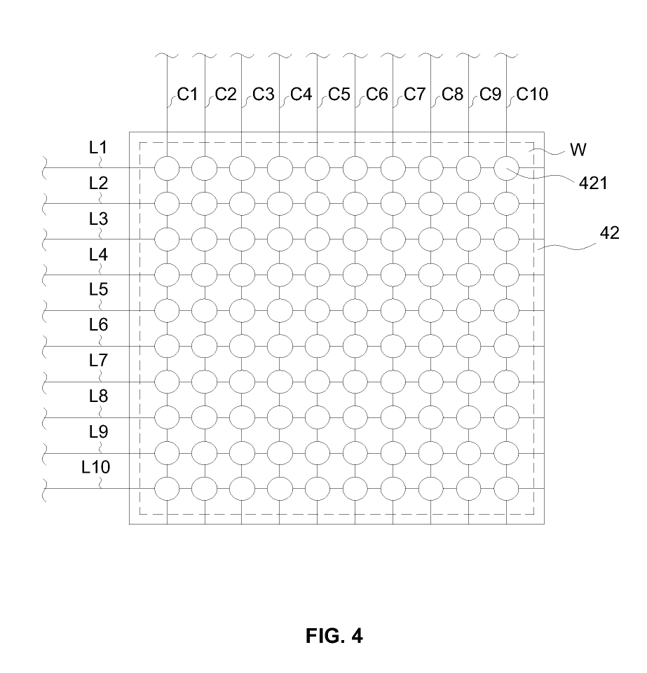

Also referring to FIG. 4, which is a schematic view illustrating a global illumination zone in accordance with the first embodiment of the present invention, when the display panel 41 of the display device 4 needs to display images in the global illumination zone thereof, the backlight module 42 enables all the illuminants 421 that are covered in the global illumination zone W to give off light. By simultaneously driving all the illuminants 421 through both the first driving control lines C1-C10 of the first driving circuit 61 and the second driving control lines L1-L10 of the second driving circuit 62, the global illumination zone W is made illuminating simultaneously.

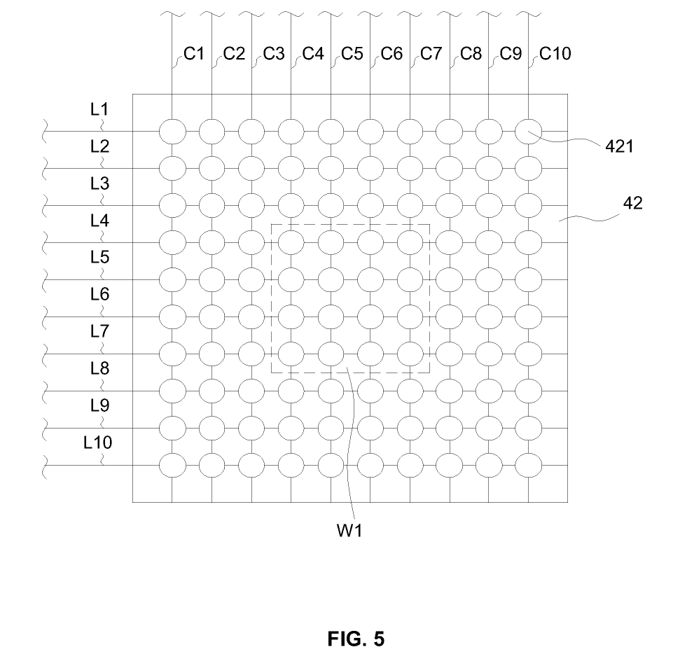

Referring to FIG. 5, which is a schematic view illustrating a local illumination zone in accordance with the first embodiment of the present invention, to display an image in a local displaying area, the illuminant controller 5 selectively drives the illuminants 421 of the backlight module 42 in accordance with the backlight illumination zone selection signal s4.

As shown, by activating the first driving control lines C4-C7 of the first driving circuit 61 and the second driving control lines L4-L7 of the second driving circuit 62 to simultaneously drive the illuminants 421 associated therewith, the backlight module 42 allows the formation of a local illumination zone W1 in accordance with a local displaying area of the global displaying area in which a target image is to be displayed so that the local illumination zone W1 is made illuminating to display the target image on the selected local displaying area.

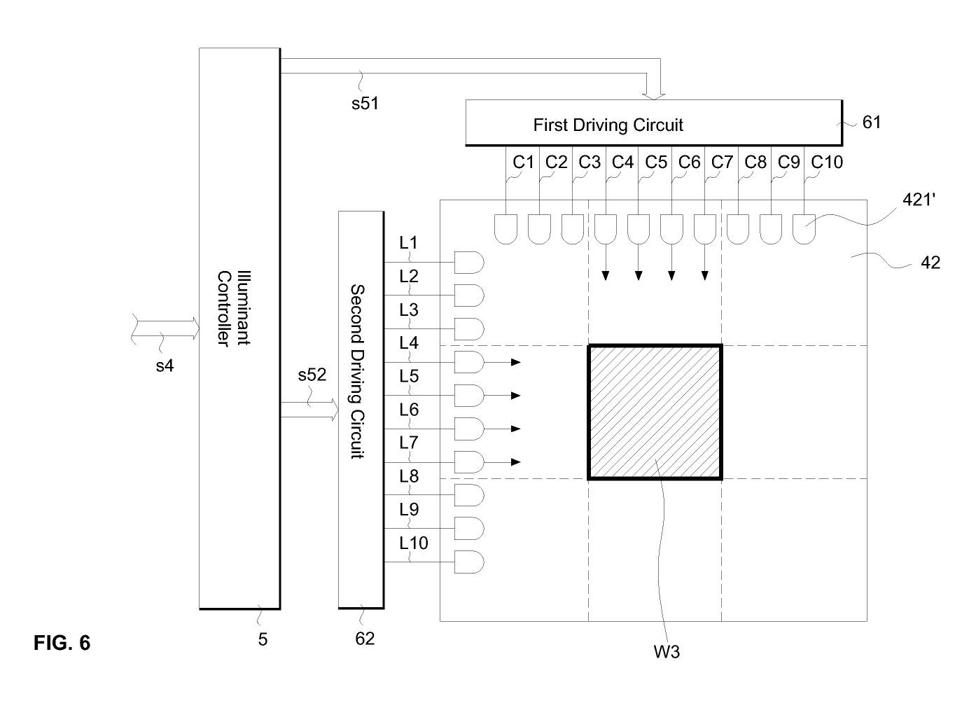

FIG. 6 shows a backlight local area illumination control circuit in accordance with a second embodiment of the present invention, as shown, the operation of the second embodiment is similar to that of the first embodiment so that identical components bear the same reference numerals and will not be repeatedly described. A difference between the two embodiment resides in that the illuminants 421′ of the backlight local area illumination control circuit 200 in the second embodiment are arranged at location close to and along two side edges of the backlight module 42 and are respectively connected to the first driving circuit 61 and the second driving circuit 62 of the illuminant controller 5.

When the illuminant controller 5 controls the first driving control lines C4-C7 of the first driving circuit 61 and the second driving control lines L4-L7 of the second driving circuit 62 in accordance with the received backlight illumination zone selection signal s4 so as to simultaneously drive the illuminants 421 covered by the control lines for giving off light, the illuminants 421′ that are thus driven give off lights that are projected to and intersect in the corresponding local illumination zone W2.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. A display device with a backlight local area illumination control circuit, the display device comprising a display panel and a backlight module and employing the backlight local area illumination control circuit to control an illumination zone of the backlight module, the backlight local area illumination control circuit comprising:
a plurality of illuminants, which are arranged in a matrix form in the backlight module corresponding to the display panel so that each illuminant generates and projects light toward the display panel to define a global illumination zone in the display panel corresponding to a global displaying area;
an illuminant driving circuit, which is connected to the illuminants of the backlight module; and
an illuminant controller, which is connected to the illuminant driving circuit and receives a backlight illumination zone selection signal;
wherein, based on the backlight illumination zone selection signal received, the illuminant controller selectively drives the illuminants of the backlight module so as to form a local illumination zone in the backlight module corresponding to a local displaying area in which a target image is to be displayed on the global displaying area to have the target image displayed in the local displaying area.

2. The display device with a backlight local area illumination control circuit as claimed in claim 1, wherein the illuminant driving circuit comprises:
a first driving circuit, which comprises a plurality of first driving control lines each being connected to a terminal of each illuminant; and
a second driving circuit, which comprises a plurality of second driving control lines each being connected to an opposite terminal of each illuminant;
wherein the illuminant controller provides a first driving signal to the first driving circuit and also provides a second driving signal to the second driving circuit to drive the illuminants of the backlight module.

3. The display device as claimed in claim 1, wherein a diffusion board is arranged between the backlight module and the display panel.

4. The display device as claimed in claim 1, wherein the display panel is connected to a display panel driving circuit, which comprises a timing controller, a data driving circuit, and a gate driving circuit, the timing controller receiving an image data signal for controlling operation timings of the data driving circuit and the gate driving circuit to drive the display panel for displaying the target image.

5. A display device with a backlight local area illumination control circuit, the display device comprising a display panel and a backlight module and employing the backlight local area illumination control circuit to control an illumination zone of the backlight module, the backlight local area illumination control circuit comprising:
a plurality of illuminants, which are arranged along at least one side edge of the backlight module so that each illuminant generates and projects light toward the display panel to define a global illumination zone in the display panel corresponding to a global displaying area;
an illuminant driving circuit, which is connected to the illuminants of the backlight module; and
an illuminant controller, which is connected to the illuminant driving circuit and receives a backlight illumination zone selection signal;
wherein, based on the backlight illumination zone selection signal received, the illuminant controller selectively drives the illuminants of the backlight module so as to form a local illumination zone in the backlight module corresponding to a local displaying area in which a target image is to be displayed on the global displaying area to have the target image displayed in the local displaying area.

6. The display device as claimed in claim 5, wherein the illuminant driving circuit comprises:
a first driving circuit, which comprises a plurality of first driving control lines each being connected to a terminal of each illuminant; and
a second driving circuit, which comprises a plurality of second driving control lines each being connected to an opposite terminal of each illuminant;
wherein the illuminant controller provides a first driving signal to the first driving circuit and also provides a second driving signal to the second driving circuit to drive the illuminants of the backlight module.

7. The display device as claimed in claim 5, wherein a diffusion board is arranged between the backlight module and the display panel.

8. The display device as claimed in claim 5, wherein the display panel is connected to a display panel driving circuit, which comprises a timing controller, a data driving circuit, and a gate driving circuit, the timing controller receiving an image data signal for controlling operation timings of the data driving circuit and the gate driving circuit to drive the display panel for displaying the target image.
